(19) United States
(12) Patent Application Publication
(10) Pub. No.: US 2025/0062422 A1
(43) Pub. Date: Feb. 20, 2025

(54) HIGH VOLTAGE BATTERY DRAIN VALVE THERMAL RUNAWAY PLUG

(71) Applicant: GM Global Technology Operations LLC, Detroit, MI (US)

(72) Inventors: Thomas F. Gorgia, III, Plymouth, MI (US); Melissa Ellul, Royal Oak, MI (US); Alex Paulsen, Royal Oak, MI (US)

(21) Appl. No.: 18/452,067

(22) Filed: Aug. 18, 2023

(51) Int. Cl. H01M 10/42; H01M 10/625

(52) U.S. Cl. CPC H01M 10/425; H01M 10/625; H01M 2010/4271; H01M 2220/20

(57) ABSTRACT

A vehicle includes a battery and a drain assembly for the battery. The battery includes a housing and a drain assembly having a first section within the housing and a second section outside of the housing. A fluid path passes through the drain assembly for flow of a fluid from the battery. A plug is disposed at a first position out of the fluid path. A retaining device retains the plug in the first position. The retaining device is configured to release the plug when an environmental parameter of the battery exceeds a threshold. A biasing device biases the plug towards a second position in the fluid path.

### INTRODUCTION

The subject disclosure relates to prevention of thermal runaway in a battery used in a vehicle and, in particular, to a temperature-controlled drain valve for a battery.

Batteries used in vehicles can include a drain valve that allows for draining of fluid from the battery. A thermal runaway event can sometimes occur in these batteries. During a thermal runaway event, the drain valve can become an unintended path for venting gas out of the battery, which can accelerate the thermal runaway. Accordingly, it is desirable to provide a drain valve that prevents unintended venting.

### SUMMARY

In one exemplary embodiment, a drain assembly for a battery is disclosed. The drain assembly includes a fluid path for flow of a fluid from the battery, a plug disposed at a first position out of the fluid path, a retaining device that retains the plug in the first position, wherein the retaining device is configured to release the plug when an environmental parameter of the battery exceeds a threshold, and a biasing device that biases the plug towards a second position in the fluid path.

In addition to one or more of the features described herein, the retaining device releases the plug when one of a temperature at the drain assembly is at or above a temperature threshold and a pressure at the drain assembly is at or above a pressure threshold. The retaining device is one of an adhesive material, a shear device, a retractable pin, and a trap door. The biasing device is one of a spring within a chamber to a side of the fluid path, an additional mass placed on the plug, and a mass of the plug. The fluid path extends between an inlet within a housing of the battery and an outlet outside of the housing and the first position is in a chamber to one side of the inlet and the second position is in front of the inlet. The drain assembly further includes a drain valve in the fluid path at the outlet. The fluid is one of an aqueous fluid, a gas, a coolant, and an electrolytic fluid.

In another exemplary embodiment, a battery for a vehicle is disclosed. The battery includes a housing, a drain assembly having a first section within the housing and a second section outside of the housing, a fluid path through the drain assembly for flow of a fluid from the battery, a plug disposed at a first position out of the fluid path, a retaining device that retains the plug in the first position, wherein the retaining device is configured to release the plug when an environmental parameter of the battery exceeds a threshold, and a biasing device that biases the plug towards a second position in the fluid path.

In addition to one or more of the features described herein, the retaining device releases the plug when one of a temperature at the drain assembly is at or above a temperature threshold and a pressure at the drain assembly is at or above a pressure threshold. The retaining device is one of an adhesive material, a shear device, a retractable pin, and a trap door. The biasing device is one of a spring within a chamber to a side of the fluid path, an additional mass placed on the plug, and a mass of the plug. The fluid path extends between an inlet in the first section and an outlet in the second section and the first position is in a chamber of the first section to one side of the inlet and the second position is in front of the inlet. The battery further includes a drain valve in the fluid path at the outlet. The fluid is one of an aqueous fluid, a gas, a coolant, and an electrolytic fluid.

In another exemplary embodiment, a vehicle is disclosed. The vehicle includes a battery having a housing and a drain assembly. The drain assembly has a first section within the housing and a second section outside of the housing, a fluid path through the drain assembly for flow of a fluid from the battery, a plug disposed at a first position out of the fluid path, a retaining device that retains the plug in the first position, wherein the retaining device is configured to release the plug when an environmental parameter of the battery exceeds a threshold, and a biasing device that biases the plug towards a second position in the fluid path.

In addition to one or more of the features described herein, the retaining device releases the plug when one of a temperature at the drain assembly is at or above a temperature threshold and a pressure at the drain assembly is at or above a pressure threshold. The retaining device is one of an adhesive material, a shear device, a retractable pin, and a trap door. The biasing device is one of a spring within a chamber to a side of the fluid path, an additional mass placed on the plug, and a mass of the plug. The fluid path extends between an inlet in the first section and an outlet in the second section and the first position is in a chamber of the first section to one side of the inlet and the second position is in front of the inlet. The vehicle further includes a drain valve in the fluid path at the outlet.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows an embodiment of a vehicle, which includes a vehicle body defining, at least in part, an occupant compartment;

FIG. 2 shows a side view of a battery pack of the vehicle, in an illustrative embodiment;

FIG. 3 shows a cross-sectional view of the drain assembly in an illustrative embodiment;

FIG. 4 shows a cross-sectional view of the drain assembly with the plug in the second position;

FIG. 5 shows a cross-sectional view of the drain assembly in another embodiment;

FIG. 6 shows a cross-sectional view of the drain assembly in another embodiment; and

FIG. 7 shows a cross-sectional view of the drain assembly in another embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features.

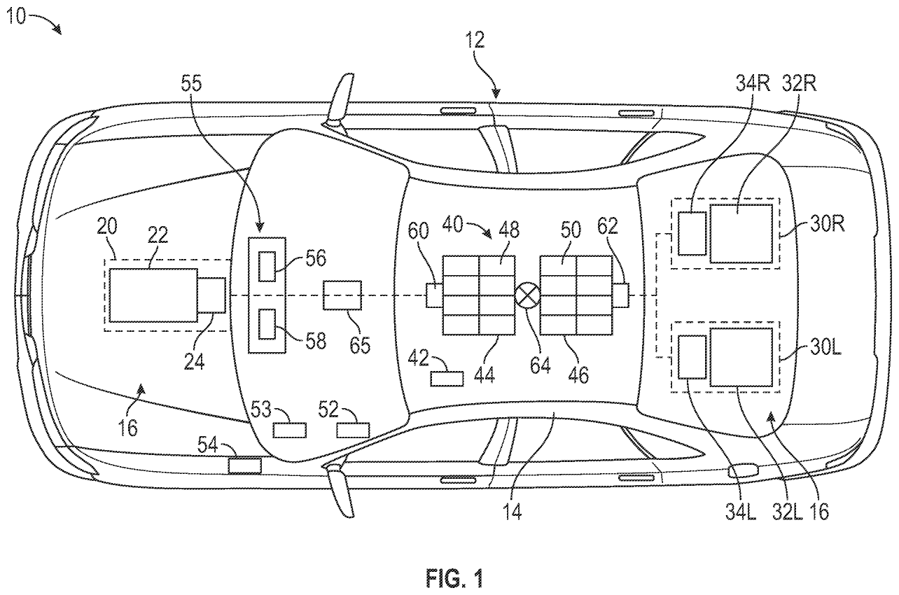

In accordance with an exemplary embodiment, FIG. 1 shows an embodiment of a vehicle 10, which includes a vehicle body 12 defining, at least in part, an occupant compartment 14. The vehicle body 12 also supports various vehicle subsystems including a propulsion system 16, and other subsystems to support functions of the propulsion system 16 and other vehicle components, such as a braking subsystem, a suspension system, a steering subsystem, and others.

The vehicle 10 may be an electrically powered vehicle (EV), a hybrid vehicle or any other vehicle. In an embodiment, the vehicle 10 is an electric vehicle that includes multiple motors and/or drive systems. Any number of drive units may be included, such as one or more drive units for applying torque to front wheels (not shown) and/or to rear wheels (not shown). The drive units are controllable to operate the vehicle 10 in various operating modes, such as a normal mode, a high-performance mode (in which additional torque is applied), all-wheel drive (“AWD”), front-wheel drive (“FWD”), rear-wheel drive (“RWD”) and others.

For example, the propulsion system 16 is a multi-drive system that includes a front drive unit 20 for driving front wheels, and rear drive units for driving rear wheels. The front drive unit 20 includes a front electric motor 22 and a front inverter 24 (e.g., front power inverter module or FPIM), as well as other components such as a cooling system. A left rear drive unit 30L includes a left rear electric motor 32L and a left rear inverter 34L. A right rear drive unit 30R includes a right rear electric motor 32R and a right rear inverter 34R. The front inverter 24, left rear inverter 34L and right rear inverter 34R (e.g., power inverter units or PIMs) each convert direct current (DC) power from a high voltage (HV) battery system 40 to poly-phase (e.g., two-phase, three-phase, six-phase, etc.) alternating current (AC) power to drive the front electric motor 22 the left rear electric motor 32L and the right rear electric motor 32R.

As shown in FIG. 1, the drive systems feature separate electric motors. However, embodiments are not so limited. For example, instead of separate motors, multiple drives can be provided by a single machine that has multiple sets of windings that are physically independent.

As also shown in FIG. 1, the drive systems are configured such that the front electric motor 22 drives the front wheels (not shown), and the left rear electric motor 32L and right rear electric motor 32R drive the rear wheels (not shown). However, embodiments are not so limited, as there may be any number of drive systems and/or motors at various locations (e.g., a motor driving each wheel, twin motors per axle, etc.). In addition, embodiments are not limited to a dual drive system, as embodiments can be used with a vehicle having any number of motors and/or power inverters.

In the propulsion system 16, the front drive unit 20, left rear drive unit 30L and right rear drive unit 30R are electrically connected to the battery system 40. The battery system 40 may also be electrically connected to other electrical components (also referred to as “electrical loads”), such as vehicle electronics (e.g., via an auxiliary power module or APM 42), heaters, cooling systems and others. The battery system 40 may be configured as a rechargeable energy storage system (RESS).

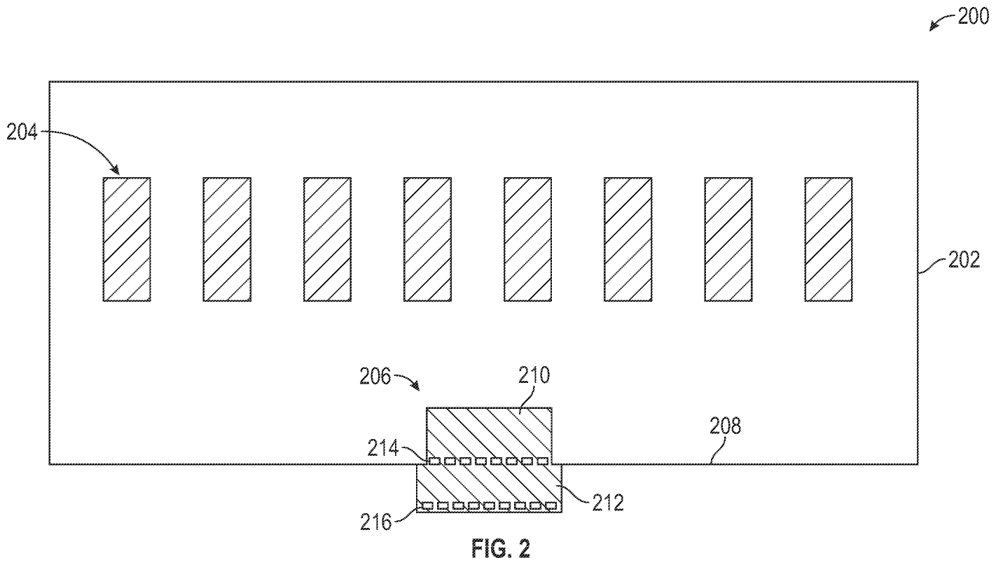

In an embodiment, the battery system 40 includes a plurality of separate battery assemblies, in which each battery assembly can be independently charged and can be used to independently supply power to a drive system or systems. For example, the battery system 40 includes a first battery assembly such as a first battery pack 44 connected to the front inverter 24, and a second battery pack 46. The first battery pack 44 includes a plurality of battery modules 48, and the second battery pack 46 includes a plurality of battery modules 50. Each battery module 48, 50 includes a number of individual cells (not shown). In various embodiments, one or more of the battery packs can include a MODACS (Multiple Output Dynamically Adjustable Capacity) battery, as described herein with respect to FIGS. 2-4.

Each of the front electric motor 22 and the left rear electric motor 32L and right rear electric motor 32R is a three-phase motor having three phase motor windings. However, embodiments described herein are not so limited. For example, the motors may be any poly-phase machines supplied by poly-phase inverters, and the drive units can be realized using a single machine having independent sets of windings.

The battery system 40 and/or the propulsion system 16 includes a switching system having various switching devices for controlling operation of the first battery pack 44 and second battery pack 46, and selectively connecting the first battery pack 44 and second battery pack 46 to the front drive unit 20, left rear drive unit 30L and right rear drive unit 30R. The switching devices may also be operated to selectively connect the first battery pack 44 and the second battery pack 46 to a charging system. The charging system can be used to charge the first battery pack 44 and the second battery pack 46, and/or to supply power from the first battery pack 44 and/or the second battery pack 46 to charge another energy storage system (e.g., vehicle-to-vehicle (V2V) and/or vehicle-to-everything (V2X) charging). The charging system includes one or more charging modules. For example, a first onboard charging module (OBCM) 52 is electrically connected to a charge port 54 for charging to and from an AC system or device, such as a utility AC power supply. A second OBCM 53 may be included for DC charging (e.g., DC fast charging or DCFC).

In an embodiment, the switching system includes a first switching device 60 that selectively connects to the first battery pack 44 to the front inverter 24, left rear inverter 34L and right rear inverter 34R, and a second switching device 62 that selectively connects the second battery pack 46 to the front inverter 24, left rear inverter 34L and right rear inverter 34R. The switching system also includes a third switching device 64 (also referred to as a “battery switching device”) for selectively connecting the first battery pack 44 to the second battery pack 46 in series.

Any of various controllers can be used to control functions of the battery system 40, the switching system and the drive units. A controller includes any suitable processing device or unit, and may use an existing controller such as a drive system controller, an RESS controller, and/or controllers in the drive system. For example, a controller 65 may be included for controlling switching and drive control operations as discussed herein.

The vehicle 10 also includes a computer system 55 that includes one or more processing devices 56 and a user interface 58. The computer system 55 may communicate with the charging system controller, for example, to provide commands thereto in response to a user input. The various processing devices, modules and units may communicate with one another via a communication device or system, such as a controller area network (CAN) or transmission control protocol (TCP) bus.

As illustrated herein, the vehicle 10 is an electric vehicle. In an alternative embodiment, the vehicle 10 can be an internal combustion engine vehicle, a hybrid vehicle, etc.

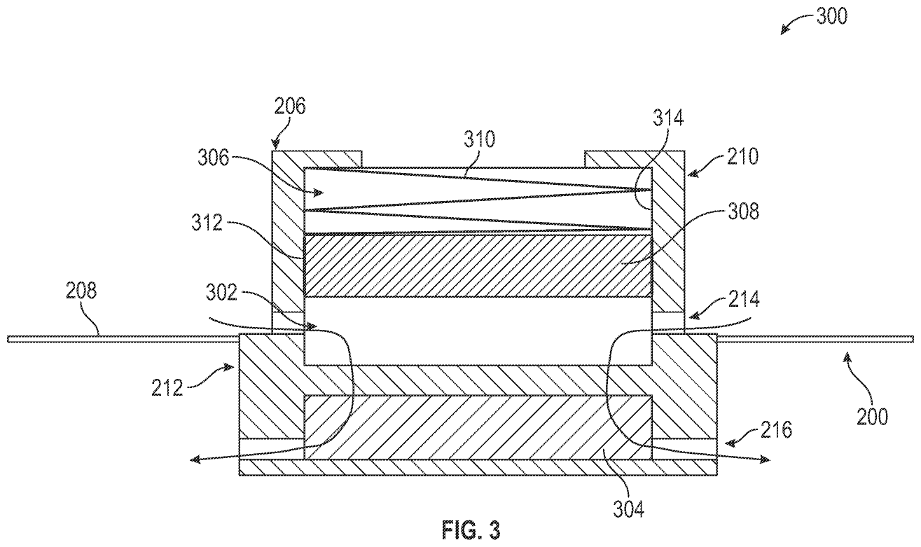

FIG. 2 shows a side view of a battery pack 200 of the vehicle 10, in an illustrative embodiment. The battery pack 200 includes a housing 202 and one or more battery cells 204 within the housing 202 for providing power to the vehicle 10. A drain assembly 206 is located at a bottom surface 208 of the housing 202 and allows aqueous fluids and gases (such as water, coolant, electrolytic fluid and any fluid containing waste products from operation of the one or more battery cells 204) to be drained from the housing 202. The drain assembly 206 includes a first section 210 that is disposed inside the housing 202 and a second section 212 that is disposed outside the housing 202. The first section 210 includes one or more inlets 214 and the second section 212 includes one or more outlets 216. A fluid path inside the drain assembly 206 connects the one or more inlets 214 of the first section 210 to the one or more outlets 216 of the second section 212, as shown in FIG. 3.

FIG. 3 shows a cross-sectional view 300 of the drain assembly 206 in an illustrative embodiment. The fluid path 302 is shown connecting the one or more inlets 214 of the first section 210 to the one or more outlets 216 of the second section 212. A drain valve 304 is disposed in the fluid path 302 within the second section 212. The drain valve 304 can be opened and closed to allow a fluid such as an aqueous fluid to flow through the fluid path 302 and out of the battery pack 200. The drain valve 304 controls fluid draining during normal operation of the battery pack 200 (i.e., when the battery is not experiencing a thermal runaway event).

The first section 210 includes a chamber 306 to a side of the fluid path 302. As shown in FIG. 3, the chamber 306 is located above the one or more inlets 214. The chamber 306 includes a plug 308 that can be moved from a first position (i.e., retracted within the chamber 306 and out of the fluid path 302) to a second position (i.e., extended into the fluid path). At the second position, the plug 308 blocks the one or more inlets 214 and prevents any fluid from flowing through the fluid path 302. A biasing device 310, such as a spring, applies a biasing force on the plug 308 in the direction of the fluid path 302. The plug 308 is held in the first position by a retaining device that provides a resistive force against biasing force of the biasing device 310.

In an embodiment, the retaining device is an adhesive material 312 that adheres to a side or circumference of the plug 308 and to an inner surface 314 of the chamber 306. The adhesive material 312 retains the plug 308 in the chamber 306 until an environmental parameter exceeds a threshold. In an embodiment, the adhesive material 312 is a temperature-sensitive material that loses its adhesive ability when a temperature of the adhesive material exceeds a temperature threshold. The temperature threshold corresponds to a temperature indicative of a thermal runaway event. When a thermal runaway event occurs, the temperature of the adhesive material exceeds the temperature threshold, and the adhesive material releases the plug 308 from the inner surface 314. The biasing device 310 then pushes the plug 308 into the fluid path 302, thereby closing the fluid path 302 and preventing or reducing unintentional venting from the battery pack 200.

In another embodiment, the adhesive material 312 is pressure-sensitive and loses its adhesive ability when the pressure within the battery pack 200 exceeds a pressure threshold. The pressure threshold corresponds to a pressure indicative of a thermal runaway event. When a thermal runaway event occurs, the pressure within the housing 202 exceeds the pressure threshold of the adhesive material 312, and the adhesive material releases the plug 308 from the inner surface 314. The biasing device 310 then pushes the plug 308 into the fluid path 302.

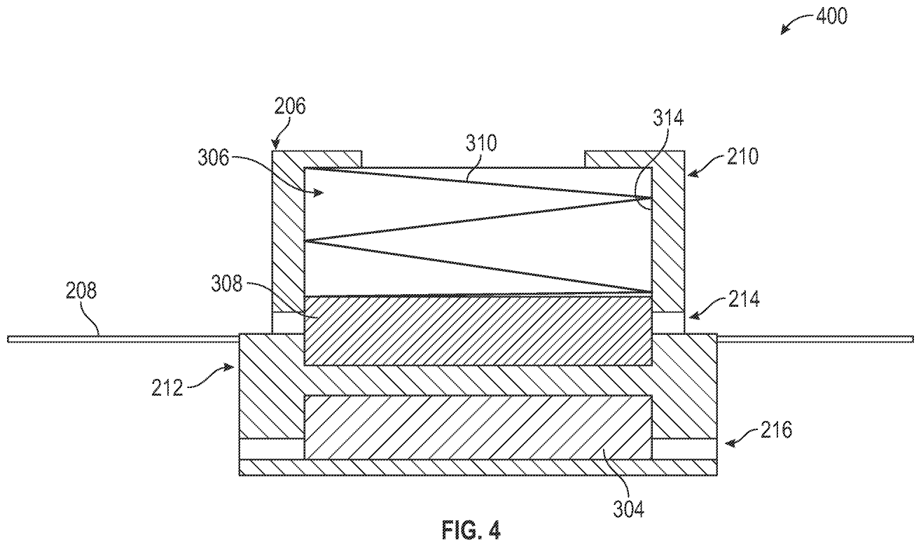

FIG. 4 shows a cross-sectional view 400 of the drain assembly 206 with the plug 308 in the second position. The plug 308 is shown extended into the fluid path 302, FIG. 3, and blocking the one or more inlets 214, thereby preventing unintentional venting from the battery pack 200 through the drain assembly 206.

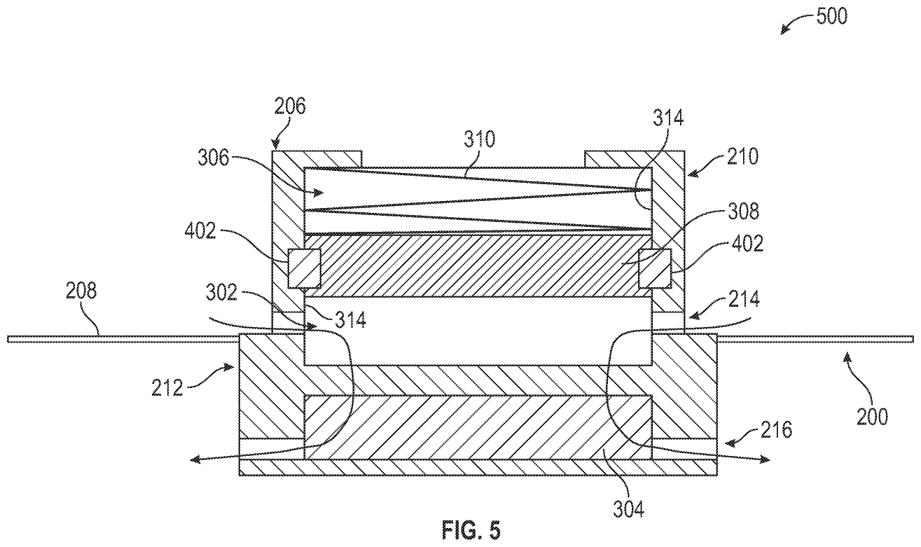

FIG. 5 shows a cross-sectional view 500 of the drain assembly 206 in another embodiment. The retaining device is a shear device 402, such as a shear pin or a shear screw, that extends into a groove in a side of the plug 308 and a recess in the wall of the chamber in order to secure the plug in the chamber at the first position. In an embodiment, the shear device 402 can be temperature sensitive. When a temperature of the shear device 402 exceeds a selected threshold, the shear device can melt, weaken or rupture, thereby releasing the plug 308 from the inner surface 314 of the chamber 306. In an alternative embodiment, the shear device 402 can be a pressure-sensitive device that can break or rupture when a pressure on the shear device exceeds a pressure threshold, thereby releasing the plug 308 from the inner surface 314 of the chamber 306. The biasing device 310 then pushes the plug 308 into the second position in the fluid path 302, thereby closing the fluid path 302 and preventing or reducing unintentional venting from the battery pack 200.

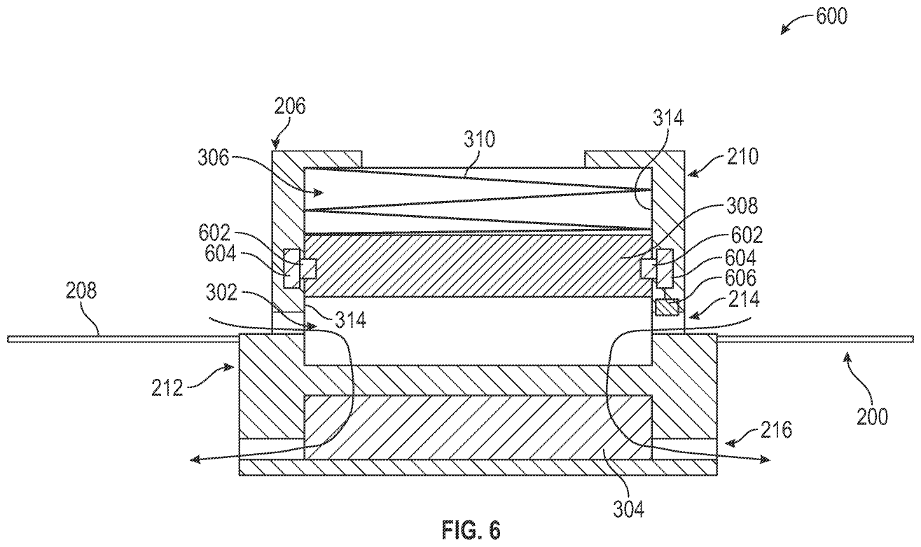

FIG. 6 shows a cross-sectional view 600 of the drain assembly 206 in another embodiment. The retaining device is a retractable pin 602 that extends into a groove in a side of the plug 308 and a solenoid 604 located in the wall of the chamber to secure the plug in the chamber 306 at the first position. When activated, the solenoid 604 can retract the retractable pin 602 from the groove of the plug 308, thereby allowing the biasing device 310 to push the plug into the second position in the fluid path 302. A sensor 606 measures at least one of a temperature and a pressure and activates the solenoid when the temperature and/or pressure exceeds a threshold to release the plug 308. The sensor 606 can be located at the one or more inlets 214 or other a suitable location.

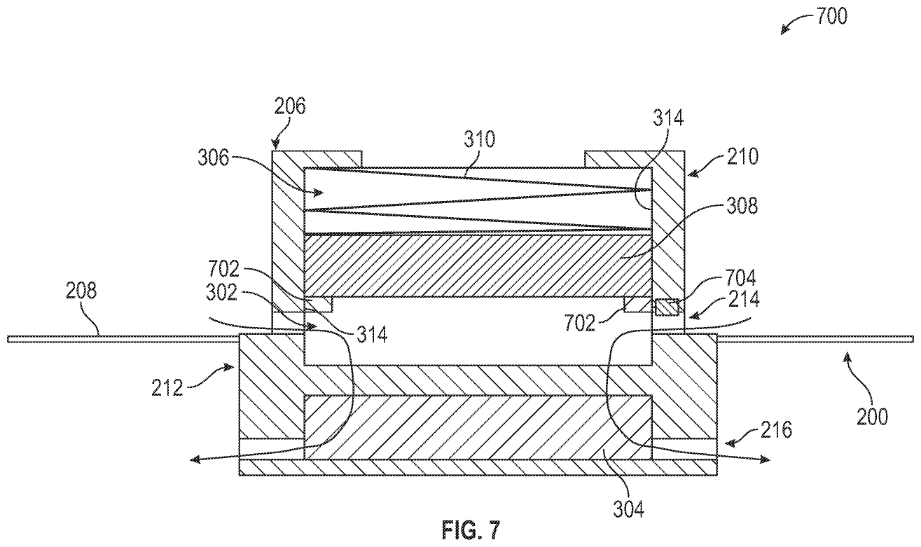

FIG. 7 shows a cross-sectional view 700 of the drain assembly 206 in another embodiment. The retaining device is a trap door 702 that is located below the plug 308 and holds the plug in the chamber 306 at the first position. A sensor 704 measures at least one of a temperature and a pressure and activates the trap door 702 to release the plug 308 when the temperature and/or pressure exceeds a threshold to release the plug 308. The biasing device 310 can then push the plug into the second position in the fluid path 302.

While the biasing device 310 has been discussed as providing the force for moving the plug 308 from the first position to the second position, in other embodiments, the plug 308 can fall into the second position due to the force of gravity on the mass of the plug once it is released from the inner surface 314, without the use of a biasing device. In addition, the biasing device can be replaced by an additional mass that is placed on top of the plug 308.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A drain assembly for a battery, comprising:
a fluid path for flow of a fluid from the battery;
a plug disposed at a first position out of the fluid path;
a retaining device that retains the plug in the first position, wherein the retaining device is configured to release the plug when an environmental parameter of the battery exceeds a threshold; and
a biasing device that biases the plug towards a second position in the fluid path.

2. The drain assembly of claim 1, wherein the retaining device releases the plug when one of: (i) a temperature at the drain assembly is at or above a temperature threshold; and (ii) a pressure at the drain assembly is at or above a pressure threshold.

3. The drain assembly of claim 1, wherein the retaining device is one of: (i) an adhesive material; (ii) a shear device; (iii) a retractable pin; and (iv) a trap door.

4. The drain assembly of claim 1, wherein the biasing device is one of: (i) a spring within a chamber to a side of the fluid path; (ii) an additional mass placed on the plug; and (iii) a mass of the plug.

5. The drain assembly of claim 1, wherein the fluid path extends between an inlet within a housing of the battery and an outlet outside of the housing and the first position is in a chamber to one side of the inlet and the second position is in front of the inlet.

6. The drain assembly of claim 5, further comprising a drain valve in the fluid path at the outlet.

7. The drain assembly of claim 1, wherein the fluid is one of (i) an aqueous fluid; (ii) a gas; (iii) a coolant; and (iv) an electrolytic fluid.

8. A battery for a vehicle, comprising:
a housing;
a drain assembly having a first section within the housing and a second section outside of the housing;
a fluid path through the drain assembly for flow of a fluid from the battery;
a plug disposed at a first position out of the fluid path;
a retaining device that retains the plug in the first position, wherein the retaining device is configured to release the plug when an environmental parameter of the battery exceeds a threshold; and
a biasing device that biases the plug towards a second position in the fluid path.

9. The battery of claim 8, wherein the retaining device releases the plug when one of: (i) a temperature at the drain assembly is at or above a temperature threshold; and (ii) a pressure at the drain assembly is at or above a pressure threshold.

10. The battery of claim 8, wherein the retaining device is one of: (i) an adhesive material; (ii) a shear device; (iii) a retractable pin; and (iv) a trap door.

11. The battery of claim 8, wherein the biasing device is one of: (i) a spring within a chamber to a side of the fluid path; (ii) an additional mass placed on the plug; and (iii) a mass of the plug.

12. The battery of claim 8, wherein the fluid path extends between an inlet in the first section and an outlet in the second section and the first position is in a chamber of the first section to one side of the inlet and the second position is in front of the inlet.

13. The battery of claim 12, further comprising a drain valve in the fluid path at the outlet.

14. The battery of claim 8, wherein the fluid is one of (i) an aqueous fluid; (ii) a gas; (iii) a coolant; and (iv) an electrolytic fluid.

15. A vehicle, comprising:
a battery having a housing;
a drain assembly having a first section within the housing and a second section outside of the housing;
a fluid path through the drain assembly for flow of a fluid from the battery;
a plug disposed at a first position out of the fluid path;
a retaining device that retains the plug in the first position, wherein the retaining device is configured to release the plug when an environmental parameter of the battery exceeds a threshold; and
a biasing device that biases the plug towards a second position in the fluid path.

16. The vehicle of claim 15, wherein the retaining device releases the plug when one of: (i) a temperature at the drain assembly is at or above a temperature threshold; and (ii) a pressure at the drain assembly is at or above a pressure threshold.

17. The vehicle of claim 15, wherein the retaining device is one of (i) an adhesive material; (ii) a shear device; (iii) a retractable pin; and (iv) a trap door.

18. The vehicle of claim 15, wherein the biasing device is one of: (i) a spring within a chamber to a side of the fluid path; (ii) an additional mass placed on the plug; and (iii) a mass of the plug.

19. The vehicle of claim 15, wherein the fluid path extends between an inlet in the first section and an outlet in the second section and the first position is in a chamber of the first section to one side of the inlet and the second position is in front of the inlet.

20. The vehicle of claim 19, further comprising a drain valve in the fluid path at the outlet.
